(19) United States
(12) Patent Application Publication
(10) Pub. No.: US 2013/0191830 A1
(43) Pub. Date: Jul. 25, 2013

(54) Managing Shared Data using a Virtual Machine

(71) Applicant: James M. Mann, Cypress, TX (US)

(72) Inventor: James M. Mann, Cypress, TX (US)

(21) Appl. No.: 13/825,570

(22) PCT Filed: Oct. 12, 2010
(86) PCT No.: PCT/US2010/052236

§ 371 Date: Mar. 22, 2013

(51) Int. Cl. G06F 9/455

(52) U.S. Cl. CPC G06F 9/45533
USPC 718/1

(57) ABSTRACT

Embodiments disclosed herein relate to managing shared data using a virtual machine. A virtual machine 110 executing on a processor may receive data from another virtual machine executing on the processor and store the received data. The virtual machine 110 may manage the stored data by processing it independent of other virtual machines executing on the processor.

### BACKGROUND

In some cases, it is desirable for an electronic device to run multiple operating systems. For example, some software programs may be limited to operating on a particular operating system and other software programs may be limited to operating on a different operating system. Separate operating environments may be desirable to separate functions, such as running two of the same type of operating systems where each is used for a different purpose. For example, one operating system may be used for work use and another may be used for personal use. A software implementation of en electronic device, such as a virtual machine, may be used to run an operating system. To allow multiple operating systems to run on an electronic device, multiple virtual machines may execute on the electronic device where each virtual machine is associated with a different operating system.

### BRIEF DESCRIPTION OF THE DRAWINGS

In the accompanying drawings, like numerals refer to like components or blocks. The drawings describe example embodiments. Steps shown in the drawings may be performed in any order. The following detailed description references the drawings, wherein:

FIG. 1 is a block diagram illustrating one example of a computing system.

FIG. 2 is a block diagram illustrating one example of a virtual machine configuration.

FIG. 3 is a flow chart illustrating one example of a method for managing shared data using a virtual machine.

FIG. 4 is a block diagram illustrating one example of a computing system.

FIG. 5 is a block diagram illustrating one example of a computing system.

FIG. 6 is a block diagram illustrating one example of managing shared data using a virtual machine.

### DETAILED DESCRIPTION

Virtual machines may be used to allow an electronic device to run multiple operating systems. For example, a processor may run a first virtual machine to run a first operating system environment and a second virtual machine to run a second operating system environment, such as a different operating system or a separate implementation of the first operating system. In some implementations, each virtual machine may have its own storage device or portion of a storage device allocated to it for storing data related to the particular virtual machine. In some cases, it may be desirable for data to be shared across multiple virtual machines. For example, a user may have music downloading software on a virtual machine for personal use on an electronic device, and the user may have a second virtual machine on the electronic device for work use. The user may want to download music from the virtual machine for personal use, but may want the downloaded music to be available on both the virtual machine dedicated to personal use and the virtual machine dedicated to work use.

Some virtual machine implementations allow data to be shared between isolated virtual machines on an electronic device. For example, a data storage associated with a first virtual machine may be mapped to a separate data storage or portion of a data storage associated with a second virtual machine. Such a system may involve complicated procedures to synchronize the data between the separate storages. In addition, because multiple virtual machines are accessing the data, any data processing, such as encryption or backup functions, may involve further synchronization. For example, if one of the virtual machines encrypts stored data, the decryption key may be sent to the other virtual machine for use when accessing the encrypted data in some cases, data is shared between visual machines by storing data in a shared data repository, such as in a remote repository accessible via a network or on a shared storage associated with the electronic device, such as a shared Universal Serial Bus (USB) drive. Again, because neither virtual machine may be in charge of the data, the configuration may involve complex synchronization for determining when and how data processing functions should be conducted as well as which virtual machine should perform each process.

In one embodiment, a management virtual machine stores and manages shared data for other virtual machines running on an electronic device. For example, the management virtual machine may store data received from a second virtual machine and may retrieve the data, such as to send to the second virtual machine or to a third virtual machine executing on the electronic device. The management virtual machine may manage stored data such that it is managed independent of virtual machines storing or accessing the data. For example, the management virtual machine may perform data processing services, such as synchronization, encryption, and data backup, such that other virtual machines do not request these processes and are not aware of these processes being performed.

Using a management virtual machine to manage data allows data management functions to be separated from the individual virtual machines communicating with the management virtual machine to store and access data. By separating both the stored data and the data processing associated with the stored data from other virtual machines, such a system allows for more efficient data management. For example, stored data may be backed up by the management virtual machine rather than backed up by multiple virtual machines. Such a system may allow data to be managed without communication between the virtual machines to synchronize the processes, such as communication related to which virtual machine should perform a process and whether it was performed. Managing the data separately from each of the individual virtual machine makes the stored data more transportable to different platforms because the data may in some case be stored in a single location. The management virtual machine itself may be moved to a different electronic device allowing the data management functions to be moved with the data. In addition, consolidating data management functions to a management virtual machine may make it easier to update data management policies. For example, to update where data is backed up, the management virtual machine may be updated without also updating the way other virtual machines handle the data.

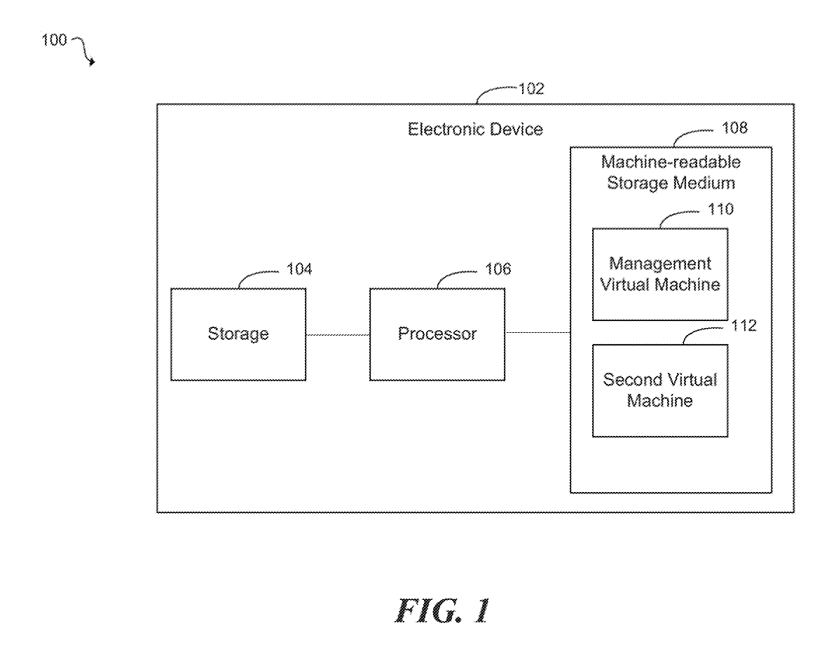

FIG. 1 is a block diagram illustrating one example of a computing system 100. The computing system 100 may include, for example, a storage 104, a processor 106, and a machine-readable storage medium 108. The storage 104 may be any suitable storage, such as a volatile or non-volatile memory. The storage 104 may be, for example, a hard disk drive, random access memory, or a flash drive. The storage 104 may be used to store data received from a virtual machine, and data may be retrieved from the storage 104 to be sent to a virtual machine.

The machine-readable storage medium 108 may be any electronic, magnetic, optical, or other physical storage device that stores executable instructions or other data (e.g., a hard disk drive, random access memory, flash memory, etc.). In one implementation, the machine-readable storage medium 108 and the storage 104 are combined into the same storage. The machine-readable storage medium 108 may include instructions executable by the processor 106, such as instructions associated with virtual machines. The machine-readable storage medium 108 may include instructions for any number of virtual machines. For example, the machine-readable storage medium 108 may include instructions associated with a management virtual machine 110 and a second virtual machine 112. In one implementation, the machine-readable storage medium 108 includes instructions for additional virtual machines. For example, the electronic device 102 may run a first operating system by executing instructions associated with the second virtual machine 112 and a second operating system by executing instructions associated with a different virtual machine.

The management virtual machine 110 and the second virtual machine 112 may be any suitable virtual appliances. In one implementation, instructions for the second virtual machine 112 and the management virtual machine 110 may both be executed. For example, a user may interact with the second virtual machine 112, and the management virtual machine 110 may execute in the background to manage data for the second virtual machine 112. In one implementation, the management virtual machine 110 performs other functions in addition to storing, accessing, and managing data stored in the storage 104.

The machine-readable storage medium 106 may include instructions associated with the management virtual machine 110 to manage data. For example, the machine-readable storage medium 108 may include instructions associated with the management virtual machine 110 to receive data from another virtual machine executing on the processor 106, store the data, and control the stored data independent of other virtual machines executing on the processor 106, where controlling the stored data comprises conducting data processing activities on the data without awareness of the other virtual machines executing on the processor 106. The management virtual machine 110 may further include instructions access the stored data and transmit the accessed data to another virtual machine executing on the processor 106.

The processor 106 may be any suitable processor. For example, the processor 106 may be one or more central processing units (CPUs), semiconductor-based microprocessors, and/or other devices suitable for retrieval and execution of instructions stored in machine-readable storage medium 108. The processor 106 may fetch, decode, and execute instructions stored in the machine-readable storage medium 108 to implement the functionality described in detail below. As an alternative or in addition to fetching, decoding, and executing instructions, the processor 106 may include one or more integrated circuits (ICs) or other electronic circuits that comprise a plurality of electronic components for performing the functionality described below. In one implementation, the processor 106 is capable of running multiple virtual machines. For example, the processor 106 may boot first operating system using the second virtual machine 112. The processor 106 may terminate the first operating system and boot a second operating system using another virtual machine in one implementation, the processor 106 executes the management virtual machine 110 to manage data while another virtual machine, such as the second virtual machine 112, is executing.

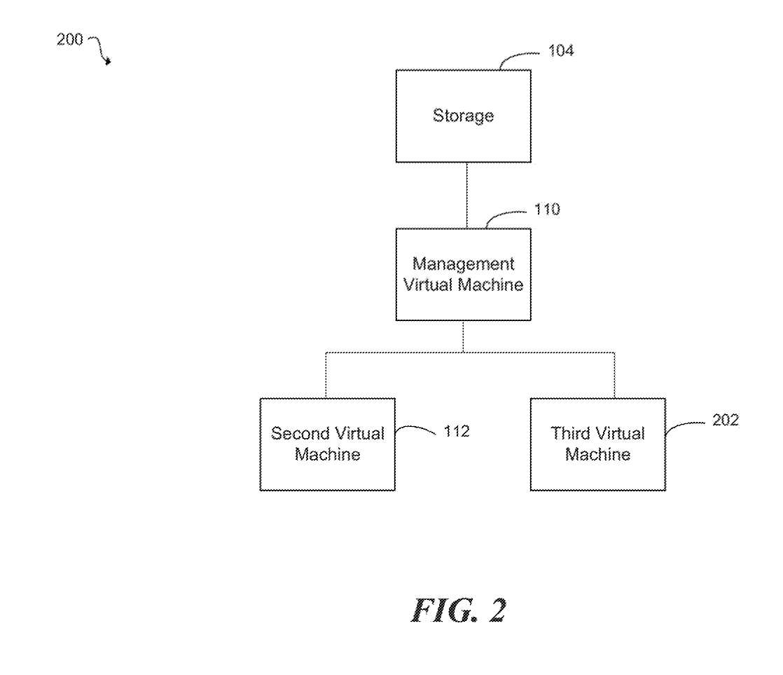

FIG. 2 is a block diagram illustrating one example of a virtual machine configuration 200. The virtual machine configuration 200 may include the management virtual machine 110 communicating with the storage 104. The management virtual machine 110 may also communicate with other virtual machines, such as the second virtual machine 112 and a third virtual machine 202, to store data for and send data to the other virtual machines executing on the processor 106. The management virtual machine 110 may communicate with any number of virtual machines running on the processor 106. In some cases, the management virtual machine 110 manages data for a subset of virtual machines capable of executing on the processor 106. The processor 106 may run multiple management virtual machines where each management virtual machine manages data for a subset of other virtual machines. In one implementation, the second virtual machine 112 and the third virtual machine 202 may store shared information using the management virtual machine 110 or may share information to be available to the particular virtual machine. For example, a user may be presented an option to store information in a shared storage or in a storage or portion of a storage dedicated to a particular virtual machine operating system.

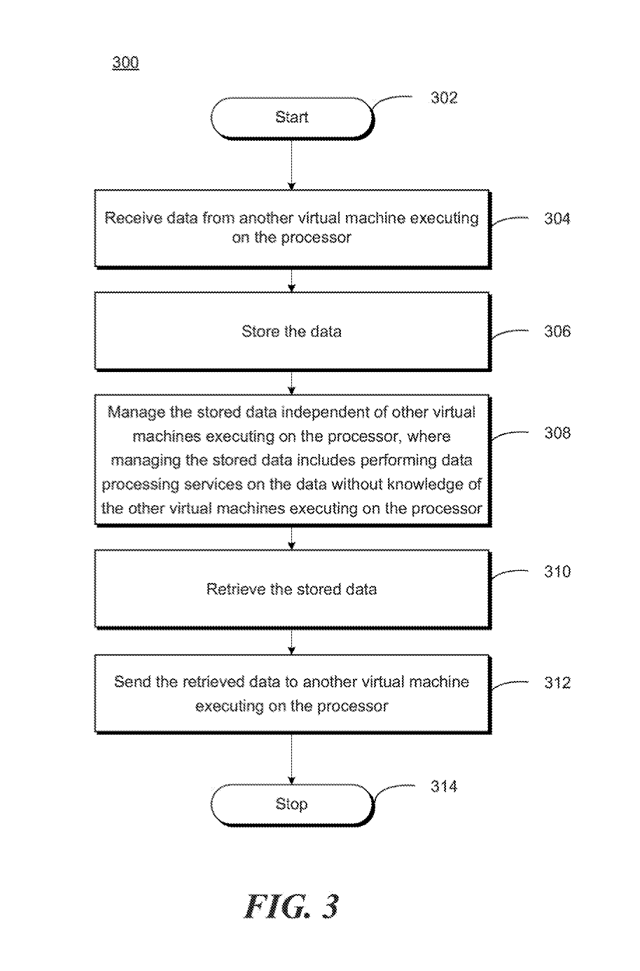

FIG. 3 is flowchart illustrating one example of a method 300 for managing shared data using a virtual machine. The management virtual machine 110 may store and retrieve data and manage stored data. For example, the management virtual machine 110 may receive data from the third virtual machine 202 for storage in the storage 104, The second virtual machine 112 or the third virtual machine 202 may then communicate with the management virtual machine 110 to retrieve the stored data from the storage 104.

In some cases, the management virtual machine 110 may manage the data in the storage 104. For example, the management virtual machine 110 may perform data processing services, such as encrypting, synchronizing, or backing up data stored in the storage 104. The management virtual machine 110 may manage the data without the knowledge of the second virtual machine 112 and the third virtual machine 202. For example, the other virtual machines may not request the data processing services or may not be aware of the details.

Beginning at block 302 and moving to block 304, the management virtual machine 110 receives data from another virtual machine executing on the processor 106. The management virtual machine 110 may receive the data from any suitable virtual machine, such as the second virtual machine 112 or the third virtual machine 202. The management virtual machine 110 may receive some data from the second virtual machine 112 for storage and some data from the third virtual machine 202 for storage in the storage 104. The received data may be any suitable data. For example, the data may be music, video, word processing, or image files. The management virtual machine 110 may receive the data in any suitable manner, such as via a network or a direct communication interface.

Moving to block 306, the management virtual machine 110 stores the data, such as in the storage 104. The management virtual machine 110 may store the data in any suitable manner. In one implementation, the management virtual machine 110 manages the data such that other virtual machines are not aware of the location in the storage 104 where the data is stored. For example, the management virtual machine 110 may store a mapping to map a location where data is actually stored compared to a location where it may appear to be stored to other virtual machines. The mapping may allow the management virtual machine 110 to move data in the storage 104, such as to defragment data, without the knowledge of other virtual machines accessing the data.

Continuing to block 308, the management virtual machine 110 manages the stored data independent of other virtual machines executing on the processor 106. For example, the processor 106 may execute instructions associated with the management virtual machine 110 to manage stored data. Controlling the stored data may include, for example, determining where to store data and retrieve data in the storage 104. In one implementation, managing the stored data includes performing data processing services on the data without knowledge of the other virtual machines executing on the processor 106. For example, the management virtual machine 110 may initiate data processing services without a request from another virtual machine, and another virtual machine may be unaware of the data processing services. The data processing services may be performed at any point, such as prior to storing data in the storage 104, after retrieving data from the storage 104 to send to a virtual machine, or while other activities unrelated to data storage are being performed by another virtual machine. The management virtual machine 110 may conduct any suitable data processing services, such as data processing activities related to synchronizing, backing up, defragmenting, or securing data.

The management virtual machine 110 may perform data processing services related to securing data stored in the storage 104. For example, the management virtual machine 110 may manage encryption for data, such as encrypting data before storing it in the storage 104 and decrypting data after retrieving data from the storage 104 prior to sending it to another virtual machine. The management virtual machine 110 may maintain information about encryption and decryption keys and about which items to encrypt. In one implementation, the management virtual machine 110 secure erases data from the storage 104 when data is deleted to provide for greater security. For example, the second virtual machine 112 may send information to the management virtual machine 110 to delete a particular piece of data stored in the storage 104, and the management virtual machine 110 may determine that the data should be securely erased. The management virtual machine 110 may perform security scans, such as virus scans on the stored data. The management virtual machine 110 may perform, for example, indexing services and performance optimizations, such as read-ahead and write-back caching for data stored in and retrieved from the storage 104.

In one implementation, the management virtual machine 110 performs data processing services related to backing up data stored in the storage 104. For example, the management virtual machine 110 may determine when to backup data or a data backup location. The management virtual machine 110 may determine which data in the storage 104 should be backed up. The management virtual machine 110 may periodically back up data, for example, by sending the data via a network to a remote storage location, or may backup data after storing it in the storage 104.

in one implementation, the management virtual machine 110 performs data processing services related to synchronizing the data stored in the storage 104. For example, the management virtual machine 110 may synchronize data with a remote storage location to determine which information should be backed up. The management virtual machine 110 may synchronize data between virtual machines. For example, the management virtual machine 110 may receive data from a virtual machine that should not be accessible to other virtual machines or a subset of other virtual machines. The management virtual machine 110 may receive information indicating that data is to be deleted such that it is no longer accessible to a particular virtual machine, but remains available to other virtual machines.

In one implementation, the virtual machine 110 performs data processing based on a virtual machine associated with the data, such as the virtual machine that stores or retrieves the data. For example, the management virtual machine 110 may encrypt data received from a particular virtual machine, such as the second virtual machine 112, where data received from other virtual machines is not encrypted, or the management virtual machine may use a stronger encryption method or a proprietary encryption method on data received from a particular virtual. As another example, the management virtual machine 110 may use real-time indexing for data received from the second virtual machine 112 and no indexing for data received from the third virtual machine 202. The management virtual machine 110 may determine which data in the storage 104 is associated with as particular virtual machine based on, for example, which virtual machine sent the data to the management virtual machine 110 for storage.

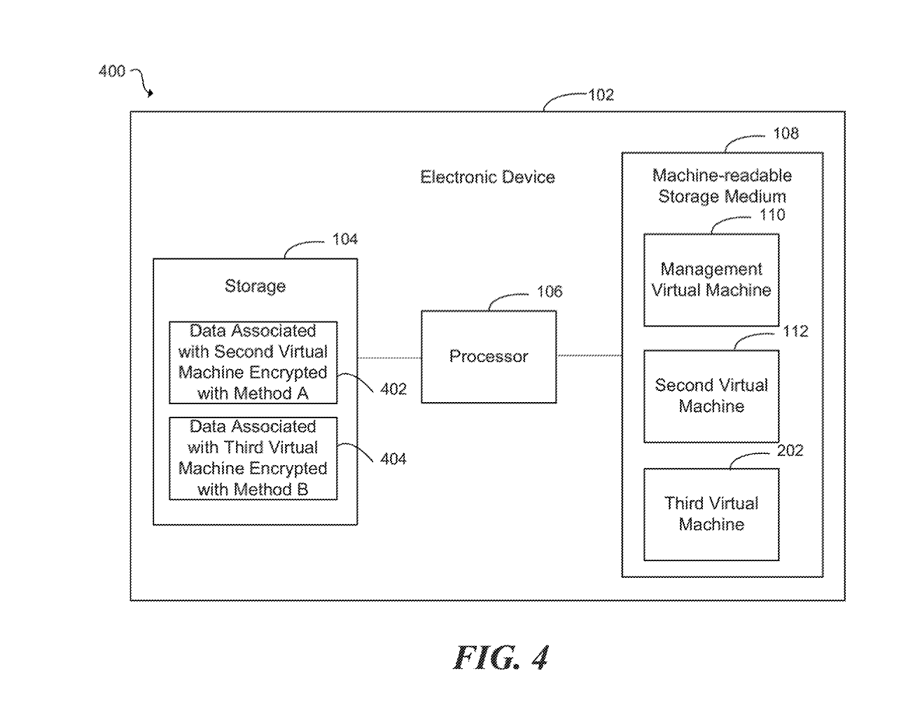

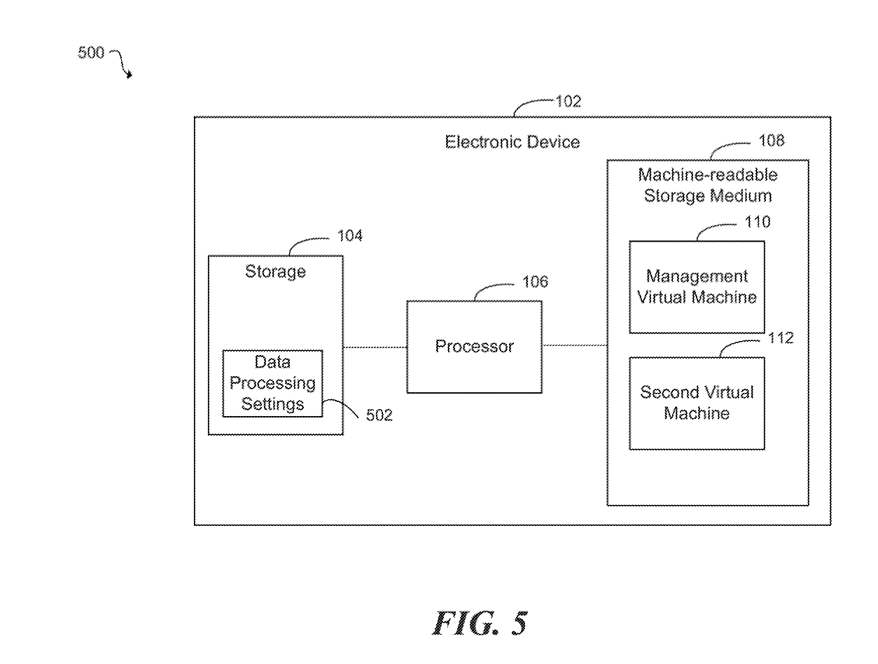

FIG. 4 is a block diagram illustrating one example of a computing system 400. The computing system 400 includes the electronic device 102 with the processor 106 and the machine-readable storage medium 108 including instructions associated with the management virtual machine 110, the second virtual machine 112, and the third virtual machine 202. The storage 104 includes data 402 associated with the second virtual machine and data 404 associated with the third virtual machine 202. The data 402 is encrypted using method A, and the data 404 is encrypted using method B. In one implementation, the management virtual machine 110 receives setting information related to performing data processing services and performs data processing services based on the setting. FIG. 5 is a block diagram illustrating one example of a computing system 500. The computing system 500 shows the electronic device 102 with the storage 104, the processor 106, and the machine-readable storage medium 108. The storage 104 includes data processing settings 502. In one implementation, the data processing settings 502 are stored in the machine-readable storage medium 108, another storage within the electronic device 102, or a remote database that the management virtual machine 110 communicates with via a network. The data processing settings 502 may be received in any suitable manner. For example, the settings may be received via user input and stored, such as in the storage 104, for later retrieval by the management virtual machine 110. In one implementation, an administrator inputs the settings such that the settings apply to multiple users' virtual machines. In one implementation, the settings are received via remote access to the electronic device 102. For example, an information technology administrator may send information to multiple user electronic devices so that a management virtual machine associated with each electronic device receives updated settings information.

The data processing settings 502 may be any suitable configuration information. The data processing settings 502 may include information, for example, about which data processing services to perform, how to perform them, or when to perform them. For example, the management virtual machine 110 may receive a setting indicating that data in the storage 104 should he backed up on a weekly basis. The data processing settings 502 may include, for example, information about whether to encrypt data or secure delete data, in one implementation, the data processing settings 502 include settings related to the type of data processing to perform on data associated with a particular virtual machine, such as settings related to data processing for data received from the second virtual machine 112 and settings related to data processing for data received from the third virtual machine 202.

The management virtual machine 110 may access the data processing settings 502 to determine how to perform data processing services on data stored in the storage 104. Allowing the settings to be input for the management virtual machine 110 may allow data in the storage 104 to be treated uniformly regardless of the virtual machine that stores or accesses data.

Referring back to FIG. 3 and proceeding to block 310, the management virtual machine 110 retrieves the stored data, such as from the storage 104. The management virtual machine 110 may access the stored data in any suitable manner. For example, the management virtual machine 110 may retrieve data from the storage 104 in response to a request from another virtual machine. The management virtual machine 110 may receive a request for data in a particular location of the storage 104 or form a location mapped to the storage 104. The management virtual machine 110 may, for example, receive a request for data from the second virtual machine 112 or the third virtual machine 202.

Continuing to block 312, the management virtual machine 110 sends the retrieved data to another virtual machine executing on the processor 106, such as the second virtual machine 112 or the third virtual machine 202. For example, the management virtual machine 110 may send retrieved data to a virtual machine requesting stored data. The management virtual machine 110 may transmit the retrieved data in any suitable manner, such as using a communication interface. The method then proceeds to block 314 and ends.

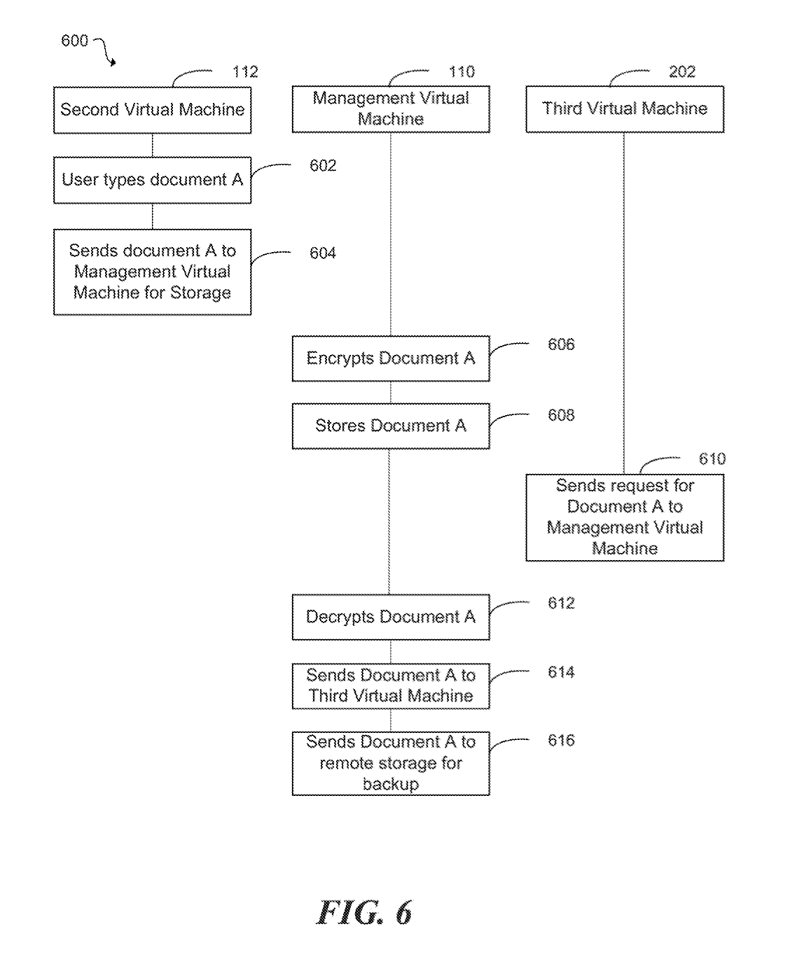

FIG. 6 is a block diagram illustrating one example 600 of managing shared data using a virtual machine. Example 500 shows the activities of the second virtual machine 112, the management virtual machine 110, and the third virtual machine 202. The electronic device 102 may first execute the second virtual machine 112 to boot a first operating system. Beginning at block 602, a user may use a word processing software program executing on the second virtual machine 112 to type document A. Moving to block 604, the user may complete typing document A and select to save document A in a shared storage. The management virtual machine 110 may be executing on the processor 106 while the second virtual machine 112 instructions are executing. The management virtual machine 110 may receive document A from the second virtual machine 112. The management virtual machine 113 may secure data for storage without the knowledge of the second virtual machine 112 and the third virtual machine 202. For example, continuing to block 606, the management virtual machine 110 may encrypt document A and proceeding to block 608, the management virtual machine 110 may store the encrypted document A.

The user may exit the second virtual machine 112 and initiate the third virtual machine 202 operating system environment. The user may run a word processing software program on the third virtual machine 202. Moving to block 610, the user may decide to open a stored document in a shared storage. The user may select document A, and a request may be sent to the management virtual machine 110 for document A. The management virtual machine 110 may receive a request for document A stored in a location in a shared storage. The management virtual machine 110 may retrieve document A. Proceeding to block 612, the management virtual machine 110 may decrypt document A so that it is in a readable format. Moving to block 614, the management virtual machine 110 may send decrypted document A to the third virtual machine 202. The third virtual machine 202 may display document A to a user. The management virtual machine 110 may perform data management functions while software on the third virtual machine 202 is in use. For example, while a user is updating document A, the management virtual machine 110 may send document A to a remote storage for backup as shown in block 616.

Using a management virtual machine to age stored data allows multiple virtual machines to share data while maintaining data management functions separate from the virtual machines sharing the data. For example, a management virtual machine may store and access data for another virtual machine and perform data processing services on the stored data. As a result, data may be managed in a more consolidated and efficient manner.

1. A computing system for managing shared data using a virtual machine 110, comprising:
a processor 106 for simultaneously executing instructions associated with multiple virtual machines;
a storage 104 for storing data shared between the virtual machines executing on the processor 106;
a virtual machine 110 comprising instructions executable by the processor 106 to:
receive data from another virtual machine executing on the processor 106;
store the data in the storage 104;
manage the stored data independent of other virtual machines executing on the processor 106, wherein managing the stored data comprises performing data processing services on the data without knowledge of the other virtual machines executing on the processor;
retrieve data from the storage 104; and
send the retrieved data to another virtual machine executing on the processor 106.

2. The computing system of claim 1, wherein receiving data from another virtual machine comprises receiving data from a second virtual machine 112 and wherein sending the retrieved data to another virtual machine comprises sending the retrieved data to the second virtual machine 112.

3. The computing system of claim 1, wherein receiving data from another virtual machine comprises receiving data from a second virtual machine 112 and wherein sending the retrieved data to another virtual machine comprises sending the retrieved data to a third virtual machine 202.

4. The computing system of claim 1, wherein performing data processing services comprises performing data security services.

5. The computing system of claim 1, wherein the virtual machine 110 further comprises instructions to:
receive a setting 402 related to data processing services,
wherein performing data processing services comprises performing data processing services based on the setting 402.

6. A method for managing data using a virtual machine 110, comprising:
receiving, by a virtual machine 110 executing on a processor 106, data from another virtual machine executing on the processor 106;
storing, by the virtual machine 110, the data;
managing, by the virtual machine 110, the stored data independent of other virtual machines executing on the processor 106, wherein managing the stored data comprises performing data processing services on the data without knowledge of the other virtual machines executing on the processor 106;
retrieving, by the virtual machine 110, the stored data; and
sending, by the virtual machine 110, the retrieved data to another virtual machine executing on the processor 106.

7. The method of claim 6, wherein performing data processing services comprises performing data backup services.

8. The method or claim 6, wherein performing data processing services comprises performing data processing services based on the virtual machine from which the data was received.

9. The method of claim 6, wherein receiving data from another virtual machine 110 comprises receiving data from a second virtual machine 112 and where sending the retrieved data to another virtual machine comprises sending the retrieved data to a third virtual machine 202.

10. The method of claim 6, further comprising:
receiving, by the virtual machine 110, a setting 402 related to data processing services,
wherein performing data processing services comprises performing data processing services based on the setting 402.

11. A machine-readable storage medium encoded with instructions executable by a processor 106 for managing data using a virtual machine 110, the machine-readable medium comprising instructions to:
execute instructions associated with a virtual machine 110 to:
receive data from another virtual machine executing on the processor 106;
store the data;
control the stored data independent of other virtual machines executing on the processor 106, wherein controlling the stored data comprises conducting data processing activities on the data without awareness of the other virtual machines executing on the processor 106;
access the stored data; and
transmit the accessed data to another virtual machine executing on the processor 106.

12. The machine-readable storage medium of claim 11, wherein instructions to receive data from another virtual machine comprises instructions to receive data from a second virtual machine 110 and instructions to transmit the accessed data to another virtual machine comprises instructions to transmit the accessed data to a third virtual machine 202.

13. The machine-readable storage medium of claim 11, wherein instructions to conduct data processing activities comprise instructions to conduct data security activities.

14. The machine-readable storage medium of claim 11, wherein instructions to conduct data processing activities comprise instructions to back up data.

15. The machine-readable storage medium of claim 11, further comprising instructions to:
receive configuration information 402 related to data processing activities,
wherein conducting data processing activities comprises conducting data processing activities based on the configuration information 402.
